(19) United States
(12) Patent Application Publication
(10) Pub. No.: US 2026/0094759 A1
(43) Pub. Date: Apr. 2, 2026

(54) TRANSFORMERS WITH HIGH-PERMEABILITY MATERIAL

(71) Applicant: LITE-ON TECHNOLOGY CORPORATION, TAIPEI CITY (TW)

(72) Inventors: Yi-Wen CHENG, TAIPEI CITY (TW); De-Jia LU, TAIPEI CITY (TW); Chen CHEN, TAIPEI CITY (TW)

(21) Appl. No.: 19/319,870

(22) Filed: Sep. 5, 2025

Related U.S. Application Data
(60) Provisional application No. 63/699,975, filed on Sep. 27, 2024.

(30) Foreign Application Priority Data
Jul. 15, 2025 (CN) 2025109731369

(51) Int. Cl. H01F 27/34; H01F 27/24; H01F 27/28

(52) U.S. Cl. CPC H01F 27/346; H01F 27/24; H01F 27/28

(57) ABSTRACT

A transformer is provided, which includes a magnetic core, primary-side and secondary-side windings, and a high-permeability material. The magnetic core includes a limb. The primary-side and secondary-side windings are configured to be wound on the limb. The secondary-side winding is located on at least one side of the primary-side winding. The secondary-side winding is spaced from the primary-side winding by a first distance. The high-permeability material is disposed at a second distance from the primary-side winding. The second distance does not exceed the first distance, and the first and second distances are in an arrangement direction of the primary-side and the secondary-side windings. The magnetic permeability of the high-permeability material is greater than that of the limb.

### CROSS REFERENCE TO RELATED APPLICATIONS

This application claims the benefit of U.S. provisional application No. 63/699,975, filed on September 27, 2024, the entirety of which is incorporated by reference herein. Additionally, this application claims the benefits of China patent application No. 2025109731369, filed on July 15, 2025, the entirety of which is incorporated by reference herein.

### TECHNICAL FIELD

The present disclosure relates to transformers, particularly to transformers with improved leakage inductance using high-permeability materials.

### BACKGROUND

The primary side architecture of a resonant converter may be a half-bridge, full-bridge, etc., while the secondary side architecture may be a full-bridge, center-tapped, etc. In a two-slot architecture, leakage inductance imbalance can occur due to current imbalance between the positive and negative half-periods. While a three-slot architecture provides a solution to current imbalance between the positive and negative half-periods, the leakage inductance is limited by the distance between the primary and secondary circuits.

### BRIEF SUMMARY

An embodiment of the present disclosure provides a transformer, comprising a magnetic core, a primary-side winding, a secondary-side winding, and a high-permeability material. The magnetic core includes a limb. The primary-side winding and the secondary-side winding are configured to be wound on the limb. The secondary-side winding is located on at least one side of the primary-side winding, and the secondary-side winding is spaced from the primary-side winding by a first distance. The high-permeability material is disposed at a second distance from the primary-side winding. The second distance does not exceed the first distance, and the first distance and the second distance are in the arrangement direction of the primary-side winding and the secondary-side winding. The magnetic permeability of the high-permeability material is greater than the magnetic permeability of the limb.

An embodiment of the present disclosure provides a transformer, comprising a magnetic core, a primary-side winding, a secondary-side winding, and a high-permeability material. The magnetic core includes a limb. The primary-side winding and the secondary-side winding are configured to be wound on the limb. The secondary-side winding is located on at least one side of the primary-side winding. The high-permeability material is configured to cover the limb, where the magnetic permeability of the high-permeability material is greater than the magnetic permeability of the limb.

### BRIEF DESCRIPTION OF THE DRAWINGS

The present disclosure can be more fully understood by reading the subsequent detailed description and examples with references made to the accompanying drawings, wherein:

FIG. 1 shows a circuit diagram of a resonant converter according to embodiments of the present disclosure.

FIG. 2 shows a line graph illustrating the effect of a distance between a high-permeability material and a primary-side winding on the leakage inductance, according to embodiments of the present disclosure.

FIG. 3A shows a side view of a transformer according to embodiments of the present disclosure.

FIG. 3B shows a perspective view of the transformer in FIG. 3A according to embodiments of the present disclosure.

FIG. 4 shows a side view of a transformer according to embodiments of the present disclosure.

FIG. 5A shows a side view of a transformer according to embodiments of the present disclosure.

FIG. 5B shows a perspective view of the transformer in FIG. 5A according to embodiments of the present disclosure.

FIG. 6 shows a side view of a transformer according to embodiments of the present disclosure.

FIG. 7A shows a side view of a transformer according to embodiments of the present disclosure.

FIG. 7B shows a diagram of a part of the transformer in FIG. 7A according to embodiments of the present disclosure.

FIG. 8A shows a side view of a transformer according to embodiments of the present disclosure.

FIG. 8B shows a diagram of a part of the transformer in FIG. 8A according to embodiments of the present disclosure.

### DETAILED DESCRIPTION

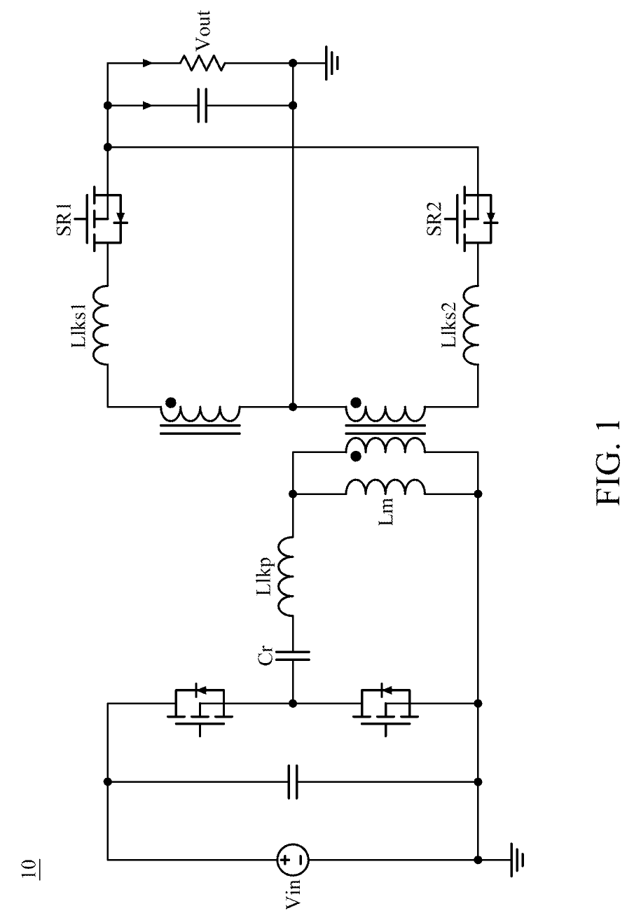

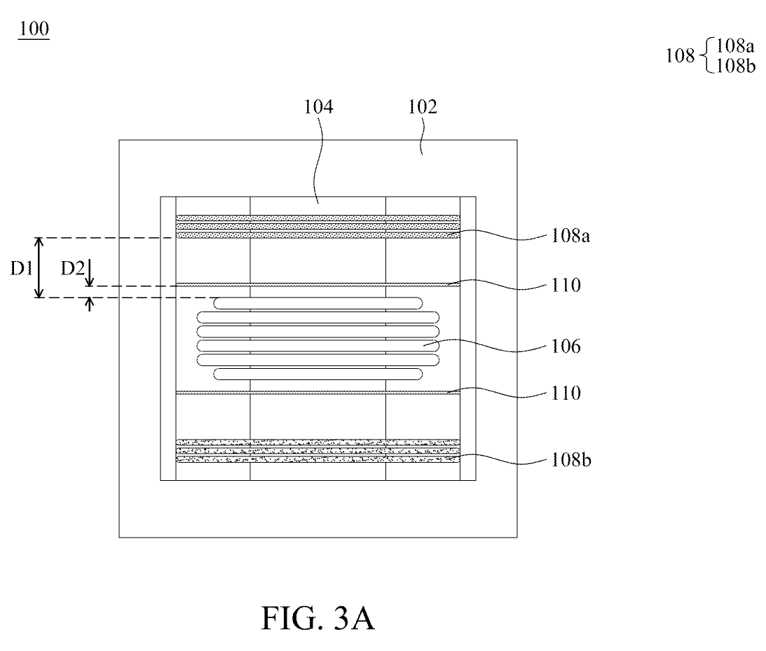

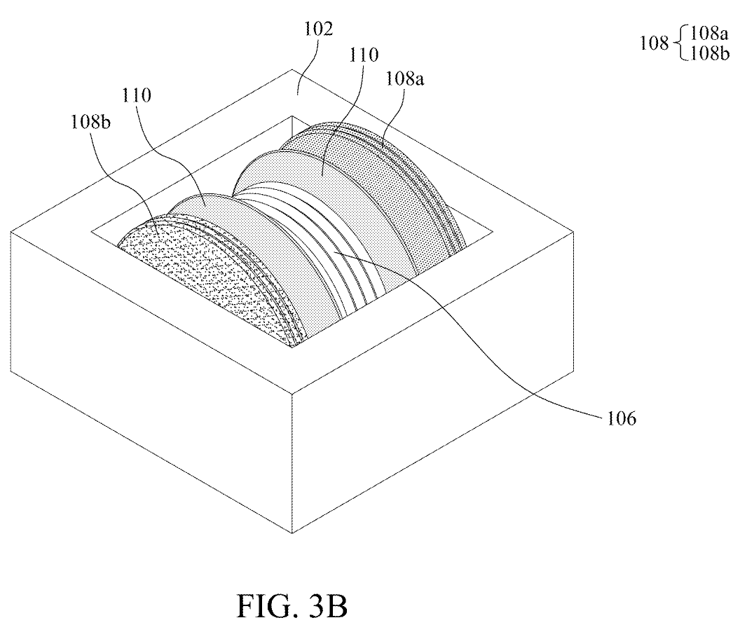

FIG. 1 shows a circuit diagram of a resonant converter 10 according to the embodiments of the present disclosure. The resonant converter 10 includes a supply voltage Vin, a resonant capacitor Cr, a primary leakage inductance Llkp, an excitation inductance Lm, secondary leakage inductance Llks1 and Llks2, switches SR1 and SR2, and an output load (including load elements such as capacitors and resistors) for outputting an output voltage Vout. Referring to FIGS. 3A to 8B, the effect generated by the combination of the limb and the primary coil of the transformer architecture provided by the present disclosure corresponds to the excitation inductance Lm. By turning on switches SR1 and SR2 in different half periods, the leakage magnetic flux that escapes due to incomplete coupling between the primary-side winding and the secondary-side winding can be utilized by high-permeability materials to increase the primary leakage inductance Llkp and secondary leakage inductance Llks1 and Llks2.

In the resonant converter 10 operating with the excitation inductance Lm, the resonant inductance (in this disclosure, the leakage inductance is used as the resonant inductance), and the resonant capacitance Cr, the use of the primary side leakage inductance Llkp as the resonant inductance reduces or replaces the need for a separate resonant inductor, thereby saving the space and other costs required for an additional inductor. However, the leakage inductance of the resonant converter 10 will be affected by the relative position or distance between the primary-side winding and the secondary-side winding, such that when this distance is too small, the leakage inductance will greatly reduce. Therefore, by adding high-permeability materials to the transformer architecture of the resonant converter 10, leakage inductance can be improved without increasing the circuit volume.

FIG. 3A shows a side view of a transformer 100 in accordance with embodiments of the present disclosure, and FIG. 3B shows a perspective view of the transformer 100 of FIG. 3A. The transformer 100 includes a magnetic core 102, a primary-side winding 106, and a secondary-side winding 108, where the magnetic core 102 includes a limb 104, and the secondary-side winding 108 includes secondary-side windings 108a and 108b. As shown in FIG. 3A, the transformer 100 further includes a high-permeability material 110 disposed between the secondary-side winding 108a and the primary-side winding 106. In FIG. 3A, secondary-side windings 108a and 108b are respectively arranged on opposite sides of primary-side winding 106. The high-permeability material 110 is disposed between the secondary-side winding 108a and the primary-side winding 106, and between the secondary-side winding 108b and the primary-side winding 106.

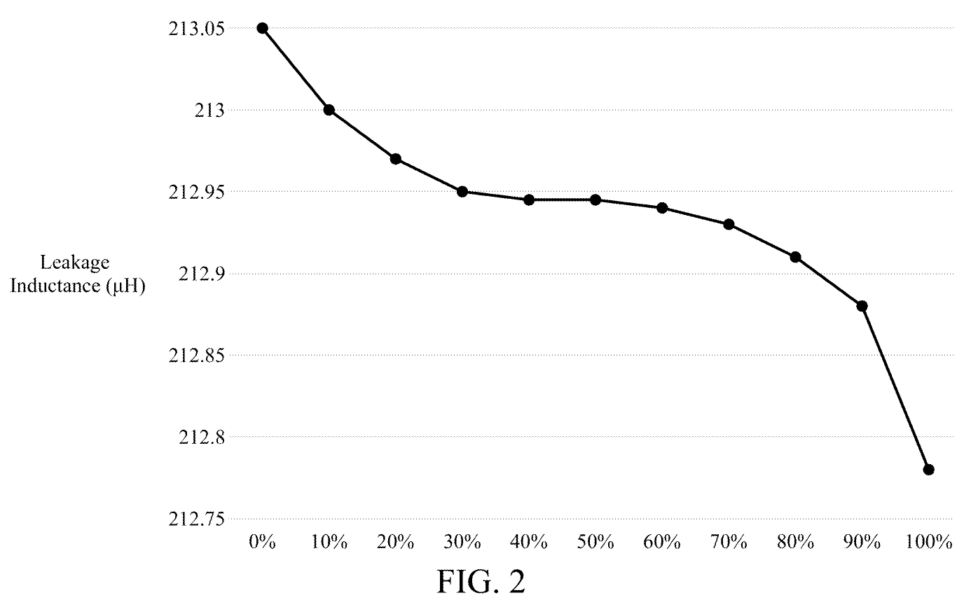

A distance D1 is between the secondary-side windings 108a and 108b and the primary-side winding 106, respectively, and there is a distance D2 between the high-permeability material 110 and the primary-side winding 106. The distance D2 is not greater than the distance D1. Since the high-permeability material 110 concentrates the magnetic flux of the transformer 100, the respective distances between the high-permeability material 110, the secondary-side windings 108a and 108b, and the primary-side winding 106 (i.e., the ratio of distances D2 and D1) have different degrees of influence on the leakage inductance generated by the transformer 100. For example, the closer the high-permeability material 110 is to the primary-side winding 106 (i.e., the smaller the distance D2), the greater the leakage inductance of the transformer 100. On the contrary, the closer the high-permeability material 110 is to the secondary-side winding 108 (i.e., the larger the distance D2), the smaller the leakage inductance of the transformer 100. In some embodiments, the distance D2 is no greater than 50%, 30%, 5%, or other proportions of the distance D1, as shown in FIG. 2. Referring to FIG. 2, the horizontal axis represents the ratio of distances D1 and D2 (for example: 0% means that distance D2 is 0% of distance D1, and 100% means that distances D1 and D2 are equal), and the vertical axis represents the leakage inductance generated by the transformer 100.

In addition, when the high-permeability material 110 is arranged between the primary-side winding 106 and the secondary-side winding 108, considering that the copper wire of the winding (or other material used as the winding) needs to extend to the outside of the magnetic core of the transformer to connect other electronic components, the high-permeability material 110 does not completely cover the secondary-side winding 108. For example, in order to output voltage, the secondary-side winding 108 includes a wire outlet that is not covered by the high-permeability material 110. In one embodiment, the wire outlet occupies less than 30% of the transverse surface of the secondary-side winding 108 (i.e., the surface perpendicular to the stacking direction of the primary-side winding 106 and the secondary-side winding 108). That is, in this embodiment, the overlap ratio of the transverse surfaces of the high-permeability material 110 and the secondary-side winding 108 is greater than 70%. The higher the overlap ratio of the transverse surfaces of the high-permeability material 110 and the secondary-side winding 108, the greater the increase in the leakage inductance.

The high-permeability material 110 has a higher magnetic permeability than the limb 104 (such as including nanocrystal strips in the high-permeability material 110). For example, the magnetic permeability of the nanocrystalline strip may be more than 10 times that of the limb 104. The high-permeability material 110 implemented with a nanocrystal strip has a multi-layer structure, including a protective film, a separation film, and a nanocrystal stack, and is stacked in a fixed direction. Referring to FIG. 3A, the stacking direction of the high-permeability material 110 is the direction in which the limb 104 extends, wherein the two outermost layers of the high-permeability material 110 are the protective and separation films. The nanocrystal stack is located between the protective and separation films, and is connected to the separation film by double-coated films. The nanocrystal stack is made up of a plurality of nanocrystal layers, where any two nanocrystal layers are connected by double-coated films.

Since the nanocrystal strip is an iron-based nanocrystal alloy (e.g., composed of elements such as iron, silicon, boron, bismuth, copper, etc.), the number (or thickness) of the nanocrystal strip and the relative position with the primary-side winding 106, the secondary-side winding 108, or the limb 104 will all affect the leakage inductance of the transformer 100. The following will be explained in detail through different examples.

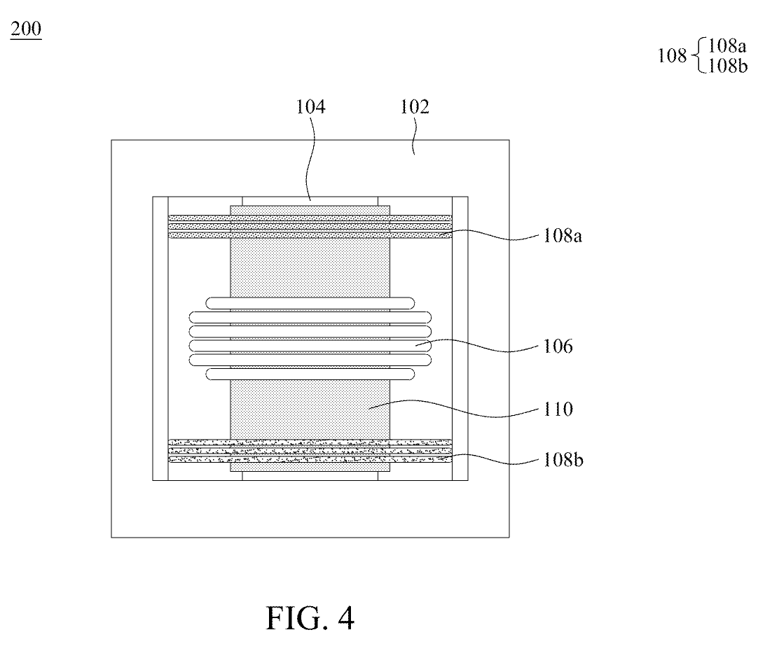

FIG. 4 shows a side view of a transformer 200 in accordance with embodiments of the present disclosure. Similar to the transformer 100, the transformer 200 has a magnetic core 102 including a limb 104, a primary-side winding 106, and a secondary-side winding 108. The transformer 200 differs in that, instead of being arranged between the primary-side winding 106 and the secondary-side winding 108a, the high-permeability material 110 is disposed to surround the limb 104. Since the magnetic flux in the surrounding air (e.g., generated by the transformer 200) is concentrated around the high-permeability material 110, the magnetic flux of the limb 104 will decrease when the high-permeability material 110 covers or surrounds the limb 104.

In addition, compared with a transformer architecture where high-permeability material 110 is not provided, the leakage inductance of the transformer 200 is higher. However, since the high-permeability material 110 is not disposed between the primary-side winding 106 and the secondary-side winding 108, the increase in the leakage inductance of the transformer 200 is smaller than that of the transformer 100.

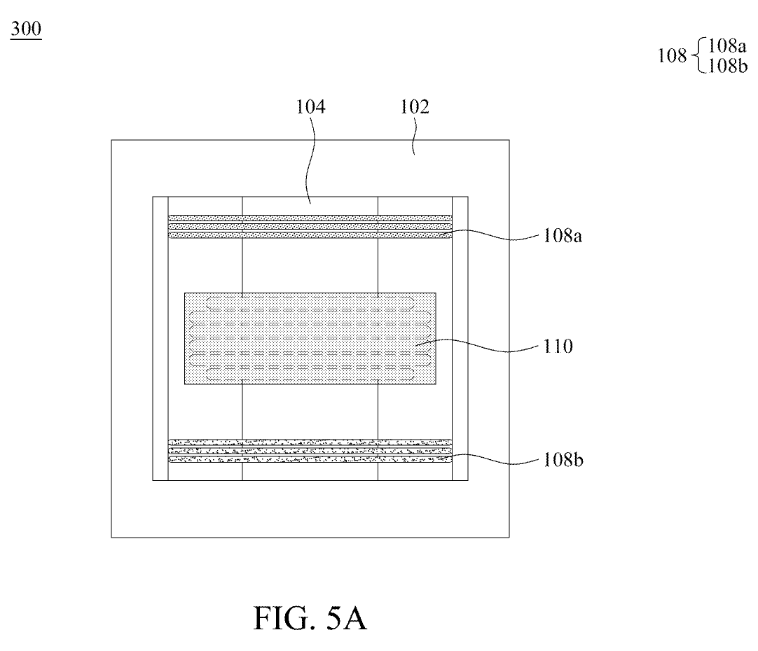

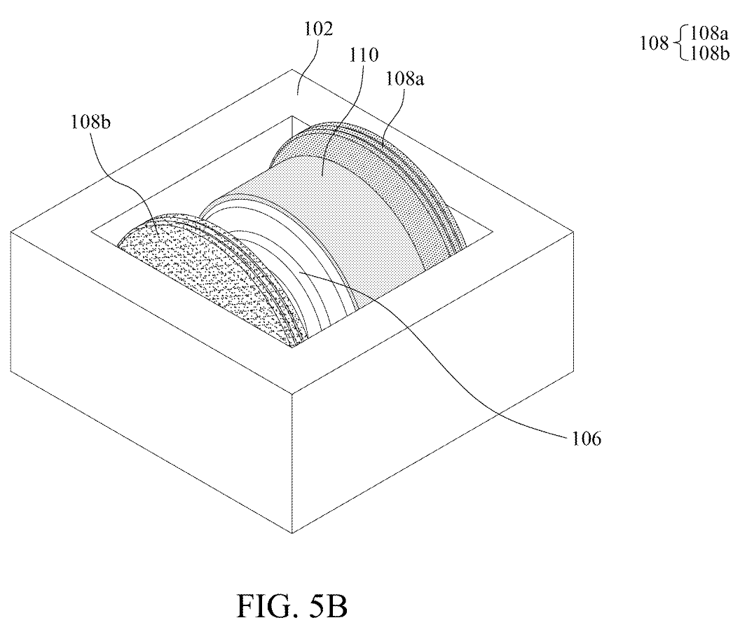

FIG. 5A shows a side view of a transformer 300 in accordance with embodiments of the present disclosure, and FIG. 5B shows a perspective view of the transformer 300 of FIG. 5A. Similar to the transformer 100, the transformer 300 has a magnetic core 102 including a limb 104, a primary-side winding 106, and a secondary-side winding 108. The transformer 300 differs in that the high-permeability material 110 is instead disposed to cover or surround the primary-side winding 106. Referring to FIG. 5B, in this embodiment, the high-permeability material 110 surrounds the primary-side winding 106.

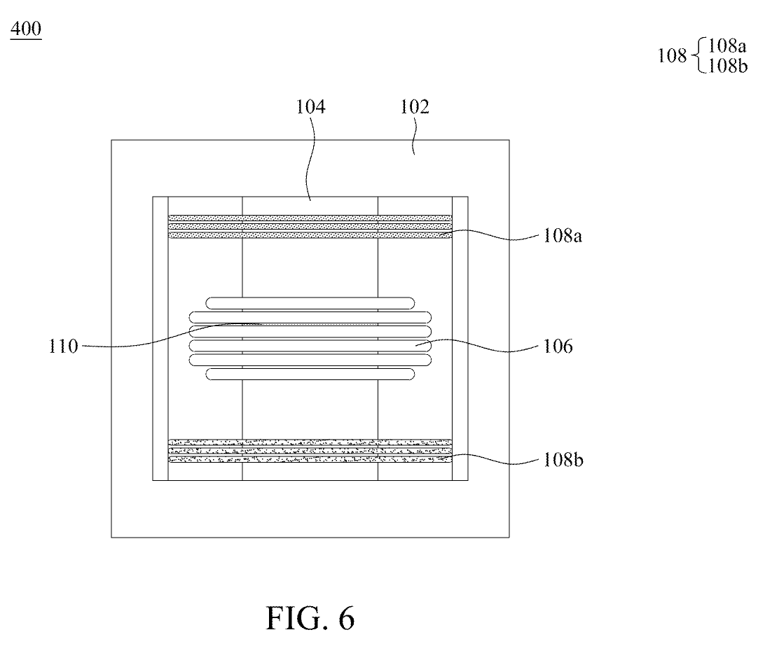

FIG. 6 is a side view of a transformer 400 shown in accordance with the disclosed embodiment. Similar to the transformer 100, the transformer 400 has a magnetic core 102 including a limb 104, a primary-side winding 106, and a secondary-side winding 108. The transformer 400 differs in that the high-permeability material 110 is instead disposed in an air gap. For example, as shown in FIG. 6, the high-permeability material 110 covers the transverse plane of the limb 104 that forms the air gap. Compared with transformers 100, 200, and 300, the high-permeability material 110 provided between the primary-side winding 106 and the secondary-side winding 108 in the transformer 400 is minimal. However, since the high-permeability material 110 still concentrates the magnetic flux, the transformer 400 still has a higher leakage inductance and a reduced total loss compared with the transformer architecture where the high-permeability material 110 is not provided.

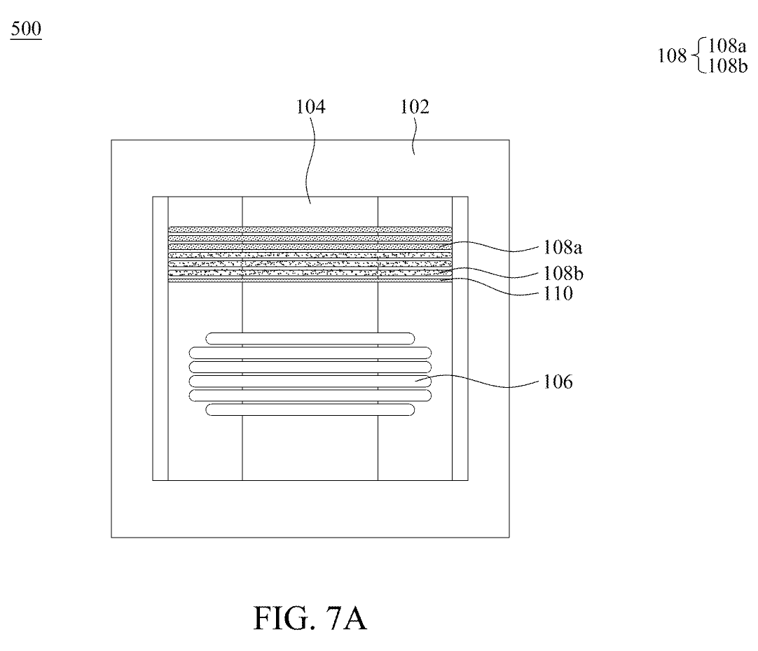

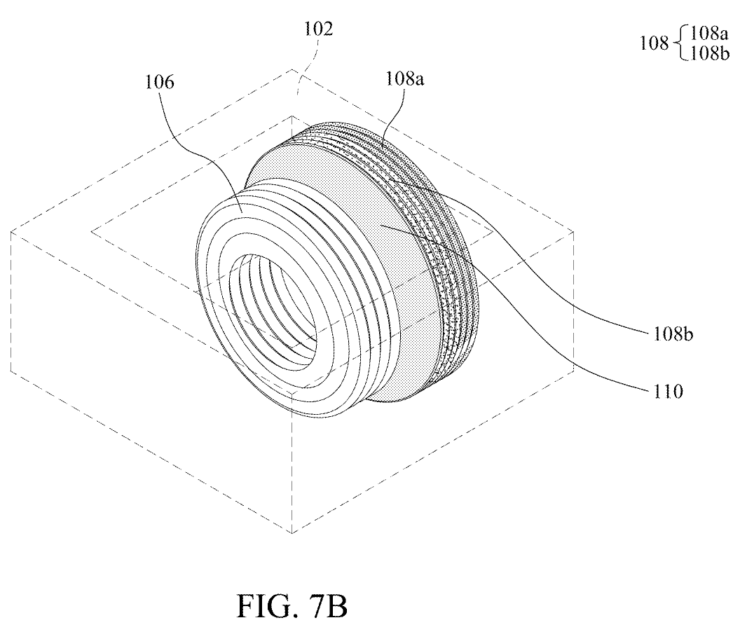

FIG. 7A shows a side view of a transformer 500 in accordance with an embodiment of the present disclosure, and FIG. 7B shows a partial schematic diagram of the transformer 500 of FIG. 7A. It is noted that, in FIG. 7B, to clearly show the relative positions of the primary-side winding 106, the secondary-side winding 108, and the high-permeability material 110, the magnetic core 102 (and the limb 104) is not shown. Similar to the transformer 100, the transformer 500 has a magnetic core 102 including a limb 104, a primary-side winding 106, and a secondary-side winding 108. The transformer 500 differs in that the secondary-side windings 108a and 108b are arranged on the same side of the primary-side winding 106, while the high-permeability material 110 is arranged between the secondary-side winding 108b and the primary-side winding 106. In this embodiment, since the high-permeability material 110 of the transformer 500 is arranged between the primary-side winding 106 and the secondary-side winding 108, the transformer 500 has a higher leakage inductance than the architecture where the high-permeability material 110 is not arranged or the high-permeability material 110 is not arranged between the primary side and the secondary-side windings.

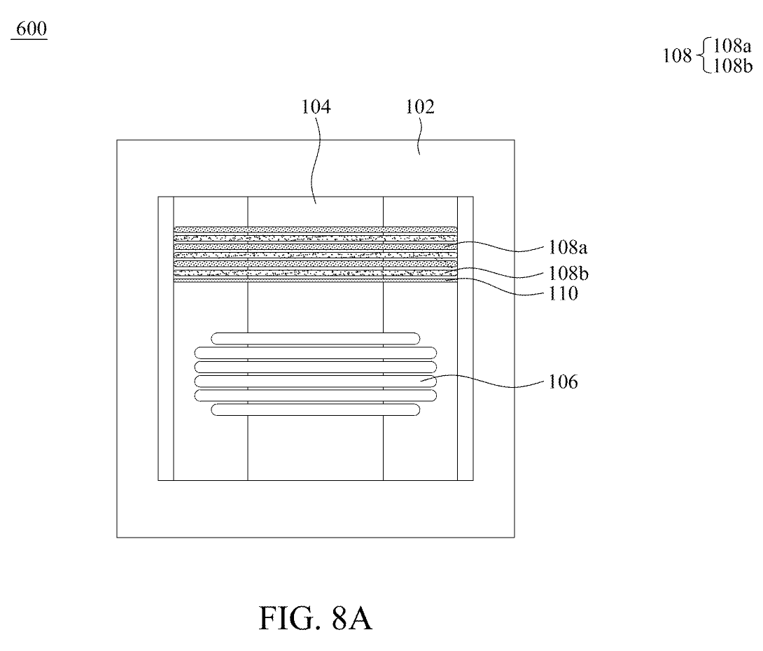

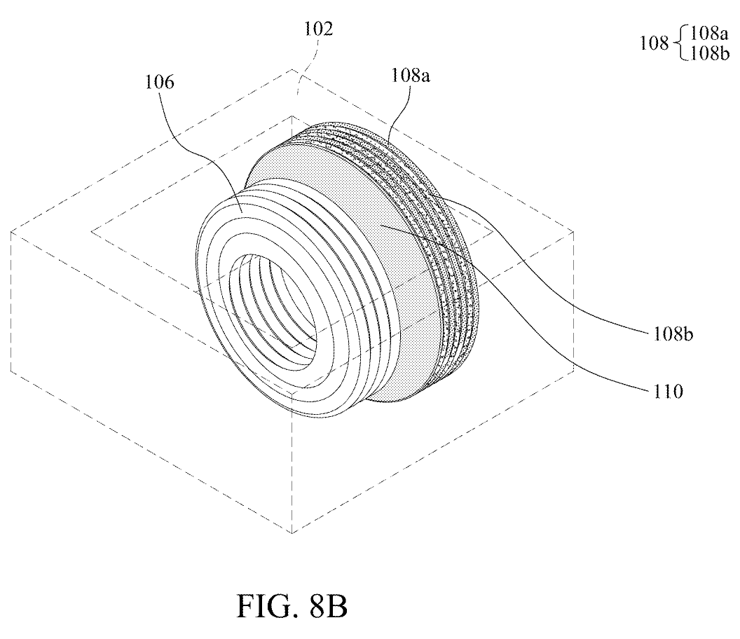

FIG. 8A shows a side view of a transformer 600 in accordance with an embodiment of the present disclosure, and FIG. 8B shows a partial schematic diagram of the transformer 600 of FIG. 8A. It is noted that, in FIG. 8B, to clearly show the relative positions of the primary-side winding 106, the secondary-side winding 108, and the high-permeability material 110, the magnetic core 102 (and the limb 104) is not illustrated. Similar to the transformer 500, the transformer 600 has a magnetic core 102 including a limb 104, a primary-side winding 106, and a secondary-side winding 108, and the secondary-side winding 108a and 108b are disposed on the same side of the primary-side winding 106, while the high-permeability material 110 is arranged between the secondary-side winding 108b and the primary-side winding 106.

The secondary-side windings 108a and 108b of the transformer 600 are arranged interleaved. Specifically, referring to FIGS. 8A and 8B, a first turn of the secondary-side winding 108a is arranged farthest from the primary-side winding 106. A first turn of the secondary-side winding 108b is arranged between the first turn and a second turn of the secondary-side winding 108a. A second turn of the secondary-side winding 108a is arranged between the first turn and a second turn of the secondary-side winding 108b, and so on until a third turn of the secondary-side winding 108b is arranged closest to the primary-side winding 106. Similarly, the secondary-side windings 108a and 108b of the transformer 600 may also be arranged in the opposite manner. That is, the first turn of the secondary-side winding 108b is set to be farthest away from the primary-side winding 106, and the remaining secondary-side windings 108a and 108b are staggered until a third turn of the secondary-side winding 108a is set to be closest to the primary-side winding 106.

Different arrangements for the high-permeability material 110 are shown in the embodiments above, and these embodiments can be combined to achieve a better leakage inductance enhancement effect and minimize the loss caused by the nanocrystal strip. For example, since the arrangement of the high-permeability material 110 between the primary-side winding 106 and the secondary-side winding 108 will result in the maximum leakage inductance enhancement effect, embodiments in which the high-permeability material 110 is not (or partly) arranged between the primary side and the secondary-side winding can be modified accordingly. For example, by combining the arrangements of the high-permeability material 110 in the transformers 100 and 300, the nanocrystal strip is also arranged between the transverse planes of the primary-side winding 106 and the secondary-side winding 108 while covering or surrounding the primary-side winding 106. In this way, compared with the transformer 300 in which only the primary-side winding 106 is covered by the high-permeability material 110, the high-permeability material 110 provided between the primary-side winding 106 and the secondary-side winding 108 will increase. In addition, compared with the transformer 100, where only the high-permeability material 110 is provided between the primary and secondary-side windings, the total usage amount (or ability to concentrate magnetic flux) of the high-permeability material 110 is higher, thereby achieving a better leakage inductance enhancement effect.

In another embodiment, the material originally used for winding can be replaced with other wires with lower loss. For example, the primary-side winding 106 and/or the secondary-side winding 108, originally implemented with copper wire (such as a flat copper sheet) may be replaced with Litz wire. The Litz wire, comprising multiple groups of insulated wires wound together, is configured to reduces the impedance of the circuit, thereby reducing losses and improving leakage inductance.

In yet another embodiment, the architecture of the transformer combines three features: (1) disposing the high-permeability material 110 between the primary-side winding 106 and the secondary-side winding 108, (2) covering/surrounding the primary-side winding with the high-permeability material 110, and (3) replacing the wires of the primary-side winding 106 and the secondary-side winding 108 with Litz lines. This configuration greatly increases the leakage inductance while minimizing the additional copper and/or iron losses caused by the high-permeability material 110.

In addition to combining the method of disposing the high-permeability material 110 of the transformer 100 and 300, the arrangements of other embodiments can also be combined, with the winding wires modification. For example, the configuration of the transformer 300 may be combined with that of transformer 500 or 600, such that the primary-side winding 106 of the transformer 500 or 600 is also covered or surrounded with a high-permeability material 110. In addition, the primary-side winding 106 and the secondary-side winding 108 are replaced with Litz wires. This allows the transformer 500 or 600 to incorporate the placement of high-permeability material 110 between the primary and secondary-side windings and the coverage of the primary-side windings, while reducing wire loss by replacing the winding wire with Litz wires.

In addition, as described above regarding FIGS. 3A and 3B, for the high-permeability material 110 made of nanocrystalline strips, the thickness (such as the number of layers), the overlap area between the high-permeability material 110 and the windings, and the relative distance and position between the high-permeability material 110 and the windings all affect the magnitude of the increase in leakage inductance. For example, increasing the thickness (such as changing from a single layer, as shown in the figures, to a multilayer) results in a greater increase in the leakage inductance. Likewise, a larger overlap area between the high-permeability material 110 and the windings leads to a greater increase in leakage inductance. When the high-permeability material 110 is disposed between the primary and secondary-side windings, the increase in leakage inductance is maximized. In addition, disposing the high-permeability material 110 closer to the primary-side winding 106 further increases the leakage inductance.

Therefore, to maximize the increase in leakage inductance and minimize the increase in losses caused by the high-permeability material 110 simultaneously, multiple layers (such as two layers, three layers, etc.) of nanocrystal strips may be disposed between the primary-side winding 106 and the secondary-side winding 108, and disposed as close as possible to the primary-side winding 106 (i.e., close to the low current side). At the same time, minimizing the area ratio of the nanocrystal strip that does not cover the winding due to the outlet part, and replacing the wires of the primary-side winding 106 and the secondary-side winding 108 with Litz wires to reduce loss. In this way, compared with a transformer architecture that does not provide a high-permeability material 110, the proposed transformer architecture can minimize the loss of the transformer itself (such as copper loss or iron loss) while maximizing the increase in leakage inductance.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. A transformer, comprising:
a magnetic core including a limb;
a primary-side winding configured to be wound on the limb;
a secondary-side winding configured to be wound on the limb, wherein the secondary-side winding is located on at least one side of the primary-side winding, the secondary-side winding is spaced from the primary-side winding by a first distance; and
a high-permeability material disposed at a second distance from the primary-side winding, wherein the second distance is configured not to exceed the first distance, and the first distance and the second distance are in an arrangement direction of the primary-side winding and the secondary-side winding,
wherein a magnetic permeability of the high-permeability material is greater than a magnetic permeability of the limb.

2. The transformer as claimed in claim 1, wherein the high-permeability material overlaps with the secondary-side winding.

3. The transformer as claimed in claim 1, wherein the limb includes an air gap, and the high-permeability material is disposed in the air gap.

4. The transformer as claimed in claim 1, wherein an overlap area between the secondary-side winding and the high-permeability material is greater than 70%.

5. The transformer as claimed in claim 1, wherein the high-permeability material does not completely overlap a wire outlet of the secondary-side winding.

6. The transformer as claimed in claim 1, wherein the high-permeability material is configured to be a nanocrystal strip.

7. The transformer as claimed in claim 6, wherein the nanocrystal strip comprises:
a protective film and a separation film; and
a nanocrystal stack including a plurality of nanocrystal layers,
wherein each of the nanocrystal layers is connected by double-coated films, and the nanocrystal stack is connected to the separation film by the double-coated films.

8. The transformer as claimed in claim 6, wherein a material of the nanocrystal strip is configured to be an iron-based nanocrystal alloy including iron, silicon, boron, bismuth, or copper, and a material of the limb is configured to be Mangan Zinc ferrite.

9. The transformer as claimed in claim 1, wherein the second distance is less than half of the first distance.

10. The transformer as claimed in claim 1, wherein the second distance is less than 30% of the first distance.

11. The transformer as claimed in claim 1, wherein the second distance is less than 5% of the first distance.

12. The transformer as claimed in claim 1, wherein the secondary-side winding includes a first secondary-side winding and a second secondary-side winding, the first secondary-side winding and the second secondary-side winding are located on the same side of the primary-side winding.

13. The transformer as claimed in claim 12, wherein the first secondary-side winding and the second secondary-side winding are arranged interleaved.

14. The transformer as claimed in claim 1, wherein the secondary-side winding includes a first secondary-side winding and a second secondary-side winding, the first secondary-side winding and the second secondary-side winding are located on opposite sides of the primary-side winding.

15. The transformer as claimed in claim 14, wherein the high-permeability material is disposed between the primary-side winding and the first secondary-side winding, or between the primary-side winding and the second secondary-side winding.

16. The transformer as claimed in claim 15, wherein the high-permeability material is further configured to surround the primary-side winding.

17. The transformer as claimed in claim 1, wherein the magnetic permeability of the high-permeability material is not less than ten times the magnetic permeability of the limb.

18. The transformer as claimed in claim 1, wherein the primary-side winding is configured to be copper wires, and the secondary-side winding is configured to be Litz wires.

19. The transformer as claimed in claim 1, wherein the primary-side winding and the secondary-side winding are configured to be Litz wires.

20. A transformer, comprising:
a magnetic core including a limb;
a primary-side winding configured to be wound on the limb;
a secondary-side winding configured to be wound on the limb, wherein the secondary-side winding is located on at least one side of the primary-side winding; and
a high-permeability material configured to cover the limb,
wherein a magnetic permeability of the high-permeability material is greater than a magnetic permeability of the limb.
